(19) United States
(12) Patent Application Publication
(10) Pub. No.: US 2009/0292625 A1
(43) Pub. Date: Nov. 26, 2009

(54) INTERACTIVE REAL-TIME ONLINE CLASS

(75) Inventors: Brian King, Redmond, WA (US); Thomas Reed Perham, Camano Island, WA (US); Erik Torgerson, Redmond, WA (US); Craig Bartholomew, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/126,931

(22) Filed: May 26, 2008

(51) Int. Cl. G06F 3/00; G06Q 30/00

(52) U.S. Cl. 705/27; 715/753

(57) ABSTRACT

A system and method for an interactive real-time online class is disclosed. In one embodiment a request to create a real-time online class may be received from an instructor. The instructor then provides class materials and the class can be indexed in a browsable or a searchable catalog of classes according to content. After the class is scheduled, the instructor can be sent a link to launch the real-time online class. In this way a student may use an online interface to browse or search the catalog of classes, request to attend the real-time online class, and then be provided a link to attend the real-time online class.

### BACKGROUND

Today, when an instructor wishes to make a live class available to the public, the instructor does not have an easy way to list or conduct a live class in an online setting where it can be easily searched for and scheduled by potential students. Further, most online classes are restrictive in that they are conducted between restricted groups of people and through a known entity, such as when an instructor at a community college provides a distance learning class to matriculated students. Furthermore authors do not have an easy way to be scheduled for their classes, set pricing for their classes, or to be paid via electronic instrument for their services, by students who intend to attend the class.

### SUMMARY

Accordingly, various embodiments for a system and method for an interactive real-time online class are described below in the Detailed Description. For example, in one embodiment a request to create a real-time online class may be received from an instructor. The instructor then provides class materials and the class can be indexed in a searchable or browsable catalog of classes according to content. After the class is scheduled the instructor can be sent a link to launch the real-time online class, be notified of the class instance from within an online account, etc. In this way a student may use an online interface to search for a class or to browse the catalog of classes, request to attend the real-time online class, and then be provided a link to attend the real-time online class.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram illustrating a first embodiment system for scheduling and conducting an interactive real-time online class.

FIG. 2 is a graphical chart of an embodiment of a method for scheduling a real-time online class.

FIG. 3 is a flowchart of an embodiment of a method for scheduling a real-time online class.

### DETAILED DESCRIPTION

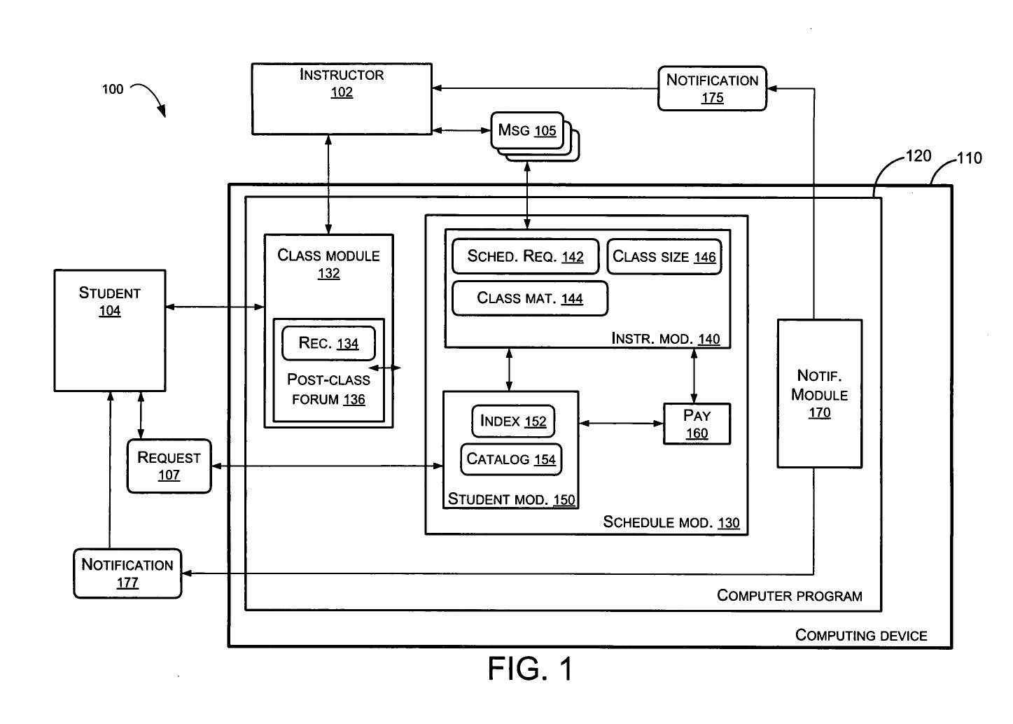

FIG. 1 illustrates a system 100 for scheduling and conducting an interactive real-time online class. The system 100 may include a computer program 120 configured to be executed on a computing device 110. The computer program 120 may be a stand-alone program, embedded code, an application programming interface (API), etc., to be run on a computing device 110 or distributed across multiple computing devices. The computer program 120 may also include a schedule module 130 to schedule a real-time online class.

In some embodiments, schedule module 130 may include an instructor module 140, a student module 150, a notification module 170 and a class module 132, which interact to set up and schedule a class, collect class materials, manage payments for the class if the class is not offered for free, establish an interface to provide information related to the one or more classes for potential students and for an instructor, conduct the class and provide a follow-up post-class forum 136 for the class, etc., as described below.

In some embodiments, system 100 may be configured to schedule and conduct an interactive real-time online class using computer program 120 configured to be executed on computing device 110, the computer program 120 including an instructor module 140 configured to receive a message 105 comprising content related to a real-time online class. Message 105 may be a schedule request 142 for real-time online class, it may include class materials 144, details about the instructor, class constraints such as a class size 146 and price to attend the class, as examples.

In one example, instructor module 140 may be configured to receive from the instructor 102 a message 105 including a range of scheduling times for the real-time online class. In an example, an instructor may be an author or presenter of learning content, and is therefore may provide classes by not only established instructors at learning institutions such as community colleges, schools, etc., but also by any person who wants to create and instruct a class in a setting other than an established learning institution.

Computer program 120 may further include a student module 150 configured to receive a request 107 to attend the real-time online class from at least one student 104. In some embodiments, student module 150 may be configured to index 152 the real-time online class, for example in a browsable catalog 154 of classes. In the embodiments described below a browsable catalog is discussed, however a browsable catalog may be a searchable catalog, a combination searchable and browsable catalog, etc. For example, in a searchable catalog a user may search by category, search term, keyword, phrase, etc. In one example, a real-time online class may be indexed according to the content of the real-time online class, wherein the student module 150 can output the browsable catalog to the at least one student 104.

As an example, the browsable catalog 154 may store class instances, class descriptions including metadata, and links to associated scheduling data. Browsable catalog 154 may be populated with information gathered about the product from the class authors or presenters. For example, the browsable catalog 154 may be filled via manual entry from an instructor, or the data may be provided programmatically via an interface, from a database on a network server, etc.

By providing a browsable catalog of a plurality of classes from multiple instructors, a student 104 may find a class directed at a specific content and determine if they want to attend the class. As an example, the student module 150 may be further configured to index 152 the real-time online class in a taxonomy that is structured according to relationships between high-level categories and the content of each class in the browsable catalog 154 of classes, thus providing an intuitive structure for a potential student to search the browsable catalog 154.

In some embodiments, the instructor module 140 may be configured to receive a payment to attend the class from the at least one student, and to distribute the payment to the instructor. For example, student module 150 may coordinate payment through an electronic payment service, wherein the online payment service may be internal to the computer program such as in payment block 160 which provides a payment to instructor module 140.

In another example, an electronic payment service may be external to computer program 120 and the student module 150 or the instructor module 140 can conduct payment for the class through the external electronic payment service. In some embodiments, the instructor module 140 may be configured to receive a message from the instructor to set a price to attend the class. Additionally, in some embodiments the computer program 120 may be configured to charge the instructor 102 for conducting the real-time online class.

Computer program 120 may further include a notification module 170 configured to send the instructor 102 a notification 175 comprising a link to launch the real-time online class. Notification module 170 may further be configured to send the at least one student 104 a notification 177 comprising a link to attend the real-time online class. In some embodiments, notification 175 and notification 177 may provide an instructor with a network or wireless address to attend or launch a class, or provide other notifying information allowing class instructors or students to schedule a class, confirm a class schedule, attend a class, etc.

Computer program 120 may further include a class module 132 configured to conduct the real-time online class between the instructor 102 and the at least one student 104. For example, class module 132 may provide an online classroom to conduct the class.

Class module 132 may be configured to create a post-class forum 136 for the at least one student 104 to communicate with other students or the instructor 102 about the class. In some embodiments, the class module 132 may be further configured to record the real-time online class and post a recording 134 of the real-time online class in the post-class forum 136, in a catalog, in a post class resources page, as non-limiting examples.

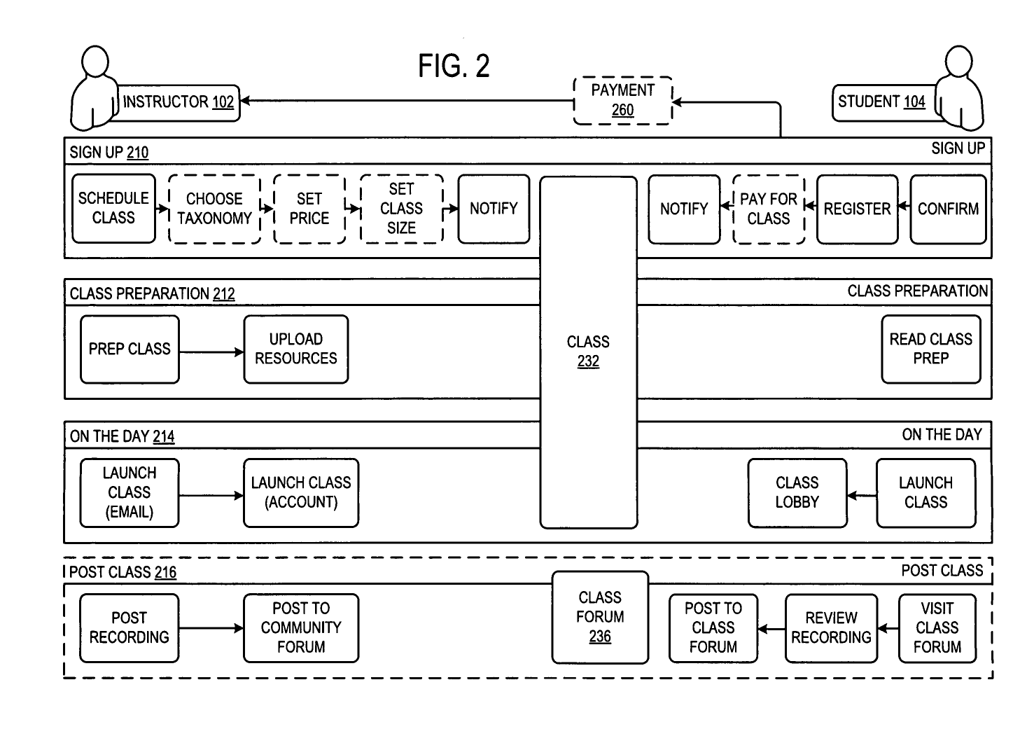

FIG. 2 is a flow chart of one embodiment including a method for scheduling, conducting and following-up on a real-time online class as provided by system 100. The flow chart in FIG. 2 is organized in four stages related to a class 232, with instructor 102 activities on the left side of the flow chart and student 104 activities on the right side of the flow chart.

In this four stage embodiment, an instructor 102 and a student 104 each establish participation in a class at the sign up stage 210. For example, the instructor may schedule the class and be sent a notification of the class being scheduled and a link or addressing information to launch the class at a specific time. Further, at the sign up stage the instructor may choose a proper placement for the class in a taxonomy of classes according to the subject matter of the class. Then, instructor 102 may set a price for attending the class, set the class size, etc.

At the sign up stage 210 and after a student has decided on a class, such as by browsing the taxonomy of classes, the student 104 may confirm they want to attend the class, register for the class and receive a notification for class time, class content, the instructor, etc. Additionally, at sign up stage 210 the student 104 may provide payment 260 for the class and the payment may be distributed to instructor 102.

The instructor and the student may then prepare for the class 232 in a class preparation stage 212. For the instructor, class preparation may include prepping for the class, uploading class materials or other resources, etc. Additionally, an instructor may prepare their personal computer to share a view of their desktop to demonstrate how to accomplish a task on a computer. For the student, the class preparation stage 212 may include reading the class materials or other resources in order to prepare for the class 232.

The third stage in FIG. 2 is directed to taking the class 232 and in this example is entitled the on the day stage 214. At this stage, the instructor 102 may launch the class 232, for example by an email, from a hyperlink on an online site, or by another suitable method, and a student 104 may also launch the class 232 and enter a class lobby to conduct the class 232.

In the example illustrated in FIG. 2, a post class stage 216 may provide a class forum 236 to communicate about or review the class 232 after the class is conducted. For example, the instructor 102 may post a recording of the class or post comments about the class to a community forum such as class forum 236. At this stage, the student 104 may visit the class forum 236, review the recording of the class, post to the class forum 236, etc.

As an example, an instructor 102 may be an advanced digital photography hobbyist and may desire to instruct a digital photograph class in a distance learning format to a student 104 who may be interested in digital photograph. Without an established instruction institution, an instructor 102 may conduct and instruct a class in an ad-hoc manner or on a one-by-one basis with someone interested in the content of the instructor's class.

By providing an online tool to schedule the class, establish the forum to conduct the class, having the instructor provide materials for the class as well as provide other constraints the regarding class size, time, etc., a student 104 or multiple students may review the class materials, instructor credentials, etc. and the instructor and students can conduct a real-time class about digital photography through an online forum that does not require an established instruction institution such as a community college.

In this way, any person who desires to conduct a class, be it a university professor who wants to altruistically instruct their academic specialty to a non-matriculated student, a hobbyist with knowledge about their hobby that may be useful to others learning the hobby, etc.

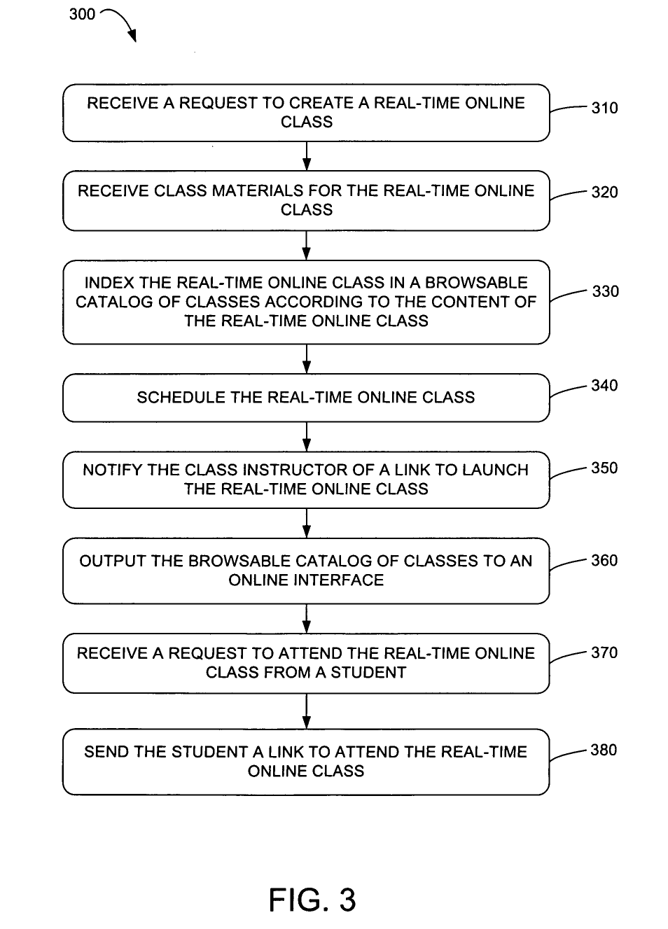

FIG. 3 is a flowchart of one embodiment of a method 300 for scheduling a real-time online class directed at instructor specified content. First, as indicated in block 310, method 300 comprises receiving a request to create a real-time online class from an instructor. This may also comprise receiving class materials for the real-time online class from the instructor, as indicated in block 320.

Then, method 300 comprises indexing the real-time online class in a browsable catalog of classes according to the content of the real-time online class, as indicated at block 330. Next, method 300 comprises scheduling the real-time online class as indicated at block 340, and notifying the instructor the class is scheduled. For example, at block 350 method 300 may notify the instructor by sending a link to launch the real-time online class.

Next, method 300 comprises outputting the browsable catalog of classes to an online interface as indicated at block 360. Then, at block 370 the method 300 comprises receiving a request to attend the real-time online class from at least one student, and at block 380 sending the at least one student a link to attend the real-time online class. After the class is set up and possible students have determined they want to attend the class, method 300 may further comprise conducting the real-time online class in on online classroom.

In some embodiments, method 300 may comprise receiving a payment to attend the class from the at least one student and distributing the payment to the instructor. For example, at block 310 an instructor may submit a price to attend the class in addition to the request to create the real-time online class. Additionally, at block 310 an instructor may submit a range of scheduling times when the instructor would prefer to conduct the real-time online class. In some embodiments, at block 310 an instructor may also set a class size restriction to restrict the class to an instructor specified number of students.

In some embodiments, method 300 may further comprise creating a post-class forum 136 for class attendees to communicate about the class. For example, a post-class forum 136 may be prepared by recording the real-time online class and posting the recording of the real-time online class in a student or instructor accessible web-page. In some embodiments, the recording of the real-time online class may be posted in a catalog of learning assets available to one or more students who did not attend the real-time online class.

It will be appreciated that the embodiments described herein may be implemented, for example, via computer-executable instructions or code, such as programs, stored on a computer-readable storage medium and executed by a computing device. Generally, programs include routines, objects, components, data structures, and the like that perform particular tasks or implement particular abstract data types.

As used herein, the term “program” may connote a single program or multiple programs acting in concert, and may be used to denote applications, services, or any other type or class of program. Likewise, the terms “computer” and “computing device” as used herein include any device that electronically executes one or more programs, including, but not limited to, personal computers and any other suitable device such as servers, laptop computers, hand-held devices, cellular phones, microprocessor-based programmable consumer electronics and/or appliances, routers, gateways, hubs and other computer networking devices.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A method for scheduling a real-time online class directed at instructor specified content, the method comprising:
receiving a request to create a real-time online class from an instructor;
receiving class materials for the real-time online class from the instructor;
indexing the real-time online class in a searchable catalog of classes according to the content of the real-time online class;
scheduling the real-time online class;
sending the instructor a link to launch the real-time online class;
outputting the searchable catalog of classes to an online interface;
receiving a request to attend the real-time online class from at least one student; and
sending the at least one student a link to attend the real-time online class.

2. The method of claim 1, further comprising:
receiving a payment to attend the class from the at least one student; and
distributing the payment to the instructor.

3. The method of claim 2, further comprising conducting the real-time online class in on online classroom.

4. The method of claim 1, further comprising outputting the searchable catalog to the at least one student to allow the at least one student to quickly find a class according to content.

5. The method of claim 1, wherein scheduling the real-time online class comprises receiving a range of scheduling times from the instructor.

6. The method of claim 1, further comprising creating a post-class forum for class attendees to communicate about the class.

7. The method of claim 6, further comprising:
recording the real-time online class; and
posting the recording of the real-time online class in the post-class forum.

8. The method of claim 1, wherein indexing the real-time online class in a searchable catalog of classes according to the content of the real-time online class further comprises indexing the real-time online class in a taxonomy, wherein the taxonomy is structured according to relationships between high-level categories and the content of each class in the searchable catalog of classes.

9. The method of claim 1, further comprising:
receiving a class size restriction from the instructor; and
restricting a number of students attending the class to the class size restriction.

10. The method of claim 1, further comprising charging the instructor for conducting the real-time online class.

11. A system for scheduling and conducting an interactive real-time online class, the system comprising a computer program configured to be executed on a computing device, the computer program including:
an instructor module configured to receive a request to schedule a real-time online class from an instructor, the instructor module further to receive class materials for the real-time online class from the instructor;
a student module configured to index the real-time online class in a searchable catalog of classes according to the content of the real-time online class and to output the searchable catalog of classes to an online interface, the student module further configured to receive a request to attend the real-time online class from at least one student;
a notification module configured to send the instructor a link to launch the real-time online class and further configured to send the at least one student a link to attend the real-time online class; and
class module configured to conduct the real-time online class between the instructor and the at least one student in an online classroom.

12. The system of claim 11, wherein the instructor module is further configured to receive a payment to attend the class from the at least one student, and to distribute the payment to the instructor.

13. The system of claim 11, wherein the student module is further configured to output the searchable catalog to the at least one student to allow the at least one student to find a class directed at a specific content.

14. The system of claim 11, wherein the instructor module is further configured to receive a message from the instructor to set a price to attend the class.

15. The system of claim 11, wherein the instructor module is further configured to receive from the instructor a range of scheduling times for the real-time online class.

16. The system of claim 11, wherein the class module is further configured to create a post-class forum for the at least one student to communicate with other students or the instructor about the class.

17. The system of claim 16, wherein the class module is further configured to record the real-time online class, and post a recording of the real-time online class in the post-class forum.

18. The system of claim 11, wherein the student module is further configured to index the real-time online class in a taxonomy that is structured according to relationships between high-level categories and the content of each class in the searchable catalog of classes.

19. The system of claim 11, wherein the computer program is further configured to charge the instructor for conducting the real-time online class.

20. A computer-readable medium comprising instructions executable by a computing device to schedule a real-time online class, the instructions being executable to perform a method comprising:
receiving a request to create a real-time online class from an instructor;
receiving class materials for the real-time online class from the instructor;
indexing the real-time online class in a searchable catalog of classes according to the content of the real-time online class;
scheduling the real-time online class;
sending the instructor a link to launch the real-time online class;
outputting the searchable catalog of classes to an online interface;
receiving a request to attend the real-time online class from at least one student; and
sending the at least one student a link to attend the real-time online class.

21. The computer-readable medium of claim 20, further comprising instructions to make the link for the instructor available as part of an online account for the instructor, and further comprising instructions to make the link for the at least one student available as part of an account for the at least one student.
